(19) United States
(12) Patent Application Publication
(10) Pub. No.: US 2013/0150511 A1
(43) Pub. Date: Jun. 13, 2013

(54) ORGANOSILICON COMPOUND AND METHOD FOR PREPARING SAME, COMPOUNDING AGENT FOR RUBBER, AND RUBBER COMPOSITION

(71) Applicant: Shin-Etsu Chemical Co., Ltd., Tokyo (JP)

(72) Inventor: Munenao HIROKAMI, Annaka-shi (JP)

(73) Assignee: SHIN-ETSU CHEMICAL CO., LTD., Tokyo (JP)

(21) Appl. No.: 13/706,415

(22) Filed: Dec. 6, 2012

(30) Foreign Application Priority Data
Dec. 7, 2011 (JP) 2011-267720

(51) Int. Cl. C08K 5/548

(52) U.S. Cl. CPC C08K 5/548
USPC 524/265; 556/426; 106/481

(57) ABSTRACT

There is disclosed an organosilicon compound of the following general formula (1):

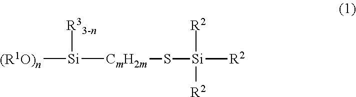

wherein R¹ is an alkyl group or an aryl group, R² is an alkyl group, an aryl group, an aralkyl group, an alkenyl group or an organoxy group, R³ is an alkyl group or an aryl group, n is an integer of 1 to 3, and m is an integer of 1 to 3.

### CROSS-REFERENCE TO RELATED APPLICATION

This non-provisional application claims priority under 35 U.S.C. §119(a) on Patent Application No. 2011-267720 filed in Japan on Dec. 7, 2011, the entire contents of which are hereby incorporated by reference.

### TECHNICAL FIELD

This invention relates to an organosilicon compound having a hydrolyzable silyl group and a sulfur-silicon bond in the molecule and a compounding agent for rubber containing the compound, and also to a rubber composition formulated with the compounding agent for rubber and a tire obtained from the rubber composition.

### BACKGROUND ART

Sulfur-containing organosilicon compounds are useful as an essential ingredient for making tires made of silica-filled rubber compositions. The silica-filled tires have improved performance in applications of automobile and are particularly excellent in wear resistance, rolling resistance and wet gripping performance. Such an improved performance is closely associated with an improvement in the low fuel consumption of tire and has been extensively studied recently.

For an improved low fuel consumption, it is essential to raise a filling rate of silica in rubber compositions. Although the silica-filled rubber composition reduces the rolling resistance of tire and is improved in wet gripping performance, such a rubber composition is high in unvulcanized viscosity and needs multi-stage kneading, thus presenting a problem on workability. Accordingly, in rubber compositions merely formulated with an inorganic filler such as silica, the filler suffers from the lack of dispersion, thus leading to the problem in that breakdown strength and wear resistance considerably drop. To avoid this, it has been essential to use a sulfur-containing organosilicon compound that is able to improve dispersibility of an inorganic filler in rubber and acts to chemically bond the filler with a rubber matrix (see Patent Document 1: JP-B S51-20208).

It is known in the art that the sulfur-containing organosilicon compounds including compounds having an alkoxysilyl group and a polysulfide silyl group in the molecule such as, for example, bis-triethoxysilylpropyltetrasulfide, and bis-triethoxysilylpropyldisulfide are effective (see Patent Documents 2 to 5: JP-T 2004-525230, JP-A 2004-18511 and JP-A 2002-145890, and U.S. Pat. No. 6,229,036).

Aside from the organosilicon compounds having a polysulfide group, there are known applications of a blocked mercapto group-containing organosilicon compound of a thioester type which is favorable for dispersion of silica and a sulfur-containing organosilicon compound of a type wherein an amino alcohol compound is interesterified at the site of a hydrolyzable silyl group that is favorable for affinity for silica via hydrogen bond (see Patent Documents 6 to 10: JP-A 2005-8639, JP-A 2008-150546 and JP-A 2010-132604, JP 4571125 and U.S. Pat. No. 6,414,061).

However, the use of such sulfur-containing organosilicon compounds has never arrived at obtaining a rubber composition for tire capable of realizing a desired low fuel consumption. Additionally, when compared with sulfide-based compounds, costs are higher and many other problems have been left including a problem on productivity ascribed to a complicated production process.

As to techniques of forming a sulfur-silicon bond, there are known (1) a technique of reacting a compound having a mercapto group with chlorosilane in the presence of an amine base such as triethylamine or the like, (2) a technique of forming a sulfur-metal bond by reaction of a compound having a mercapto group with a metallic base such as sodium methoxide, followed by subsequent reaction with chlorosilane, (3) a technique of forming a sulfur-sodium bond by reaction of a compound having a polysulfide group with sodium and subsequently reacting with chlorosilane, and (4) a technique of reacting a compound having a mercapto group with a silazane compound in the presence of an amine catalyst such as an imidazole or the like.

However, in (1) and (2) above, not less than an equimolar amount of a base is required and a large amount of filtrate is produced. Additionally, a large amount of solvent is needed, resulting in very low productivity. In (3), sodium that is difficult to handle is used and a large amount of filtrate is formed, so that productivity is very low. In (4), there is a problem in that since a silazane is used as a starting material, a compound having a simple substituent can be just prepared.

### SUMMARY OF INVENTION

An object of the invention is to provide a sulfur-containing organosilicon compound which can solve the problems of the above prior-art techniques, allows the hysteresis loss of the resulting rubber composition to be significantly lowered and can remarkably improve workability. An associated object of the invention is to provide a compounding agent for rubber containing such a sulfur-containing organosilicon compound as mentioned above, a rubber composition containing the compounding agent for rubber and a tire formed from the rubber composition. Another object of the invention is to provide a method for preparing a sulfur-containing organosilicon compound, which is higher in productivity than conventional counterparts.

In order to achieve the above objects, we have made intensive studies and, as a result, found that a rubber composition making use of a compounding agent for rubber composed mainly of a sulfur-containing organosilicon compound having a hydrolyzable silyl group and a sulfur-silicon bond satisfies low fuel consumption tire characteristics and can remarkably improve workability.

Accordingly, the invention provides an organosilicon compound and a method for preparing the compound, a compounding agent for rubber, a rubber composition, and a tire set forth below.

[1] An organosilicon compound of the following general formula (1):

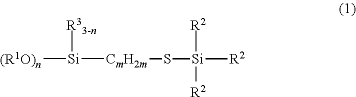

wherein R¹ is an unsubstituted or substituted alkyl group having 1 to 10 carbon atoms or an unsubstituted or substituted aryl group having 6 to 10 carbon atoms, R² is independently an unsubstituted or substituted alkyl group having 1 to 20 carbon atoms, an unsubstituted or substituted aryl group having 6 to 10 carbon atoms, an unsubstituted or substituted aralkyl group having 7 to 10 carbon atoms, an unsubstituted or substituted alkenyl group having 2 to 10 carbon atoms or an unsubstituted or substituted organoxy group having 1 to 20 carbon atoms, R³ is an unsubstituted or substituted alkyl group having 1 to 10 carbon atoms or an unsubstituted or substituted aryl group having 6 to 10 carbon atoms, n is an integer of 1 to 3, and m is an integer of 1 to 3.
[2] The organosilicon compound of [1], characterized by being represented by the following general formula (2):

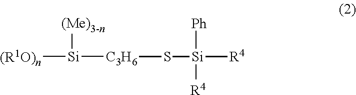

wherein R¹ and n, respectively, have the same meanings as defined above, R⁴ is independently an unsubstituted or substituted alkyl group having 1 to 20 carbon atoms, an unsubstituted or substituted aryl group having 6 to 10 carbon atoms, an unsubstituted or substituted aralkyl group having 7 to 10 carbon atoms, an unsubstituted or substituted alkenyl group having 2 to 10 carbon atoms or an unsubstituted or substituted organoxy group having 1 to 20 carbon atoms, Me is a methyl group and Ph is a phenyl group.
[3] The organosilicon compound of [1], characterized by being represented by the following general formula (3):

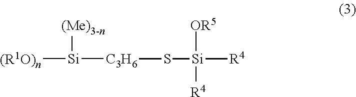

wherein R¹ and n, respectively, have the same meanings as defined above, R⁴ is independently an unsubstituted or substituted alkyl group having 1 to 20 carbon atoms, an unsubstituted or substituted aryl group having 6 to 10 carbon atoms, an unsubstituted or substituted aralkyl group having 7 to 10 carbon atoms, an unsubstituted or substituted alkenyl group having 2 to 10 carbon atoms or an unsubstituted or substituted organoxy group having 1 to 20 carbon atoms, R⁵ is an unsubstituted or substituted alkyl group having 1 to 20 carbon atoms, an unsubstituted or substituted aryl group having 6 to 10 carbon atoms, an unsubstituted or substituted aralkyl group having 7 to 10 carbon atoms or an unsubstituted or substituted alkenyl group having 2 to 10 carbon atoms, and Me is a methyl group.
[4] The organosilicon compound of [1], characterized by being represented by the following general formulas (4) to (9):

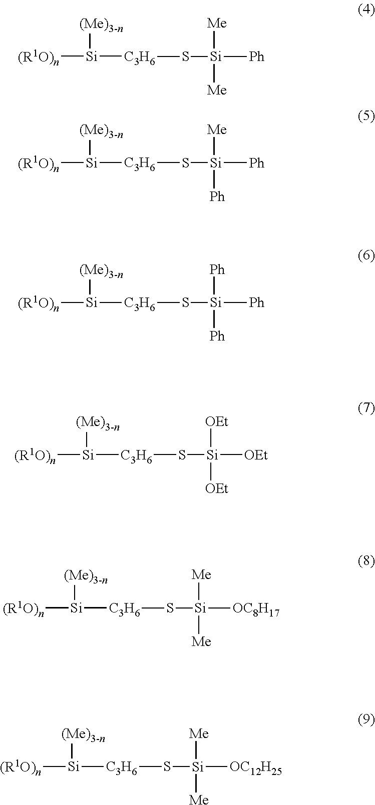

wherein R¹ and n, respectively, have the same meanings as defined above, Me is a methyl group, Et is an ethyl group and Ph is a phenyl group.
[5] The organosilicon compound of any one of [1] to [4], characterized in that R¹ represents CH₃CH₂.
[6] A method for preparing an organosilicon compound defined in [1], including reacting, in the presence of a catalyst, an organosilicon compound represented by the following general formula (i) and having a mercapto group with an organosilicon compound represented by the following general formula (ii) and having an Si—H bond to form a sulfur-silicon bond:

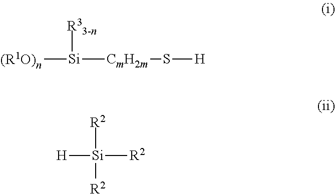

wherein R¹ is an unsubstituted or substituted alkyl group having 1 to 10 carbon atoms or an unsubstituted or substituted aryl group having 6 to 10 carbon atoms, R² is independently an unsubstituted or substituted alkyl group having 1 to 20 carbon atoms, an unsubstituted or substituted aryl group having 6 to 10 carbon atoms, an unsubstituted or substituted aralkyl group having 7 to 10 carbon atoms, an unsubstituted or substituted alkenyl group having 2 to 10 carbon atoms or an unsubstituted or substituted organoxy group having 1 to 20 carbon atoms, R³ is an unsubstituted or substituted alkyl group having 1 to 10 carbon atoms or an unsubstituted or substituted aryl group having 6 to 10 carbon atoms, n is an integer of 1 to 3, and m is an integer of 1 to 3.
[7] The method for preparing an organosilicon compound of [6], wherein the catalyst is a transition metal catalyst or a Lewis acid catalyst.
[8] The method for preparing an organosilicon compound of [7], wherein the transition metal catalyst is RhCl(PPh₃.
[9] The method for preparing an organosilicon compound of [7], wherein the Lewis acid catalyst is (pentafluorophenyl)boric acid.
[10] A compounding agent for rubber including the organosilicon compound defined in any one of [1] to [5].
[11] The compounding agent for rubber of [10], further including at least one type of powder wherein a ratio by weight of the organosilicon compound (A) and the at least one type of powder (B) is such that (A)/(B)=70/30 to 5/95.
[12] A rubber composition including the compounding agent for rubber defined in [10] or [11] and a rubber.
[13] A tire formed by use of the rubber composition defined in [12].

### ADVANTAGEOUS EFFECTS OF INVENTION

The organosilicon compound of the invention has a hydrolyzable silyl group and a sulfur-silicon bond therein wherein a mercapto group is protected with the silyl group, so that the mercapto odor can be reduced. The organosilicon compound is able to achieve a low scorch when applied as a rubber composition, can remarkably improve workability and can satisfy desired low fuel consumption tire characteristics. The preparation method of the invention is one that is much higher in productivity than existing preparation methods.

### DESCRIPTION OF EMBODIMENTS

The invention is particularly described below. It will be noted that in the practice of the invention, “silane coupling agent” is intended to be embraced in “organosilicon compound.”

### Organosilicon Compound (Silane Coupling Agent)

The features of the organosilicon compound (silane coupling agent) of the invention reside in having both structures (i) and (ii) indicated below:

(i) a hydrolyzable silyl group; and

(ii) a sulfur-silicon bond.

The organosilicon compound of the invention is represented by the following general formula (1) as having a series of structures having both structures (i) and (ii):

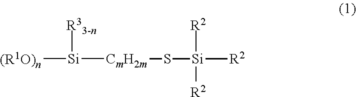

wherein R¹ is an unsubstituted or substituted alkyl group having 1 to 10 carbon atoms or an unsubstituted or substituted aryl group having 6 to 10 carbon atoms, R² is independently an unsubstituted or substituted alkyl group having 1 to 20 carbon atoms, an unsubstituted or substituted aryl group having 6 to 10 carbon atoms, an unsubstituted or substituted aralkyl group having 7 to 10 carbon atoms, an unsubstituted or substituted alkenyl group having 2 to 10 carbon atoms or an unsubstituted or substituted organoxy group having 1 to 20 carbon atoms, R³ is an unsubstituted or substituted alkyl group having 1 to 10 carbon atoms or an unsubstituted or substituted aryl group having 6 to 10 carbon atoms, n is an integer of 1 to 3, and m is an integer of 1 to 3.

The above structure can be specifically represented by the following general formula (2) or (3):

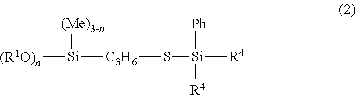

wherein R¹ and n, respectively, have the same meanings as defined above, R⁴ is independently an unsubstituted or substituted alkyl group having 1 to 20 carbon atoms, an unsubstituted or substituted aryl group having 6 to 10 carbon atoms, an unsubstituted or substituted aralkyl group having 7 to 10 carbon atoms, an unsubstituted or substituted alkenyl group having 2 to 10 carbon atoms or an unsubstituted or substituted organoxy group having 1 to 20 carbon atoms, Me is a methyl group, and Ph is a phenyl group, or

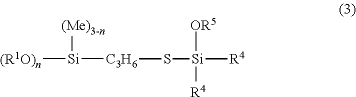

wherein R¹, n, R⁴ and Me, respectively, have the same meanings as defined above, and R⁵ is an unsubstituted or substituted alkyl group having 1 to 20 carbon atoms, an unsubstituted or substituted aryl group having 6 to 10 carbon atoms, an unsubstituted or substituted aralkyl group having 7 to 10 carbon atoms, or an unsubstituted or substituted alkenyl group having 2 to 10 carbon atoms.

More specific examples include those represented by the following general formulas (4) to (9):

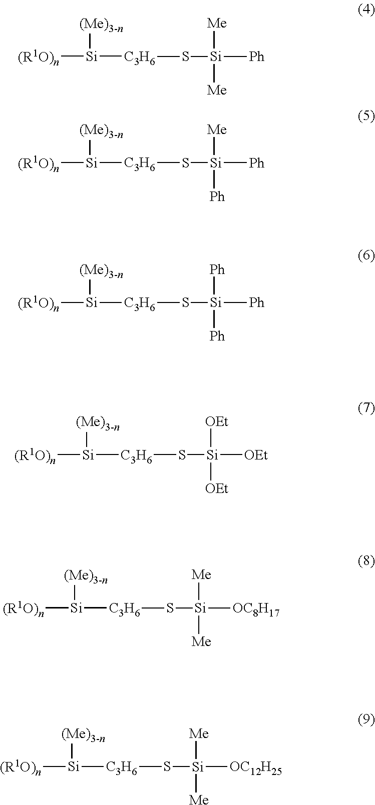

wherein R¹, n, Me and Ph, respectively, have the same meanings as defined above and Et is an ethyl group.

Still more specifically, in those compounds of the formulas (1) to (9), R¹ is preferably CH₃CH₂.

Examples of alkyl and aryl groups of R¹ include a methyl group, an ethyl group, a propyl group, a butyl group, a phenyl group and the like, of which a methyl group or ethyl group is preferred and an ethyl group is more preferred. Examples of an alkyl group of R² include a methyl group, an ethyl group, a tert-butyl group, an octyl group, a decyl group, a dodecyl group or the like. Examples of an aryl group include a phenyl group, a xylyl group, a tolyl group or the like. Examples of an aralkyl group include a benzyl group. Examples of an alkenyl group include a vinyl group, a propenyl group, a pentenyl group or the like. Examples of an organoxy group include an alkoxy group such as a methoxy group, an ethoxy group, a propoxy group, a butoxy group, an octoxy group, a dodecoxy group or the like, an aryloxy group such as a phenoxy group, or an alkenyloxy group such as a vinyloxy group, a propenyloxy group, a pentenyloxy group or the like. Preferably, R² is an alkyl group having 1 to 6 carbon atoms, a phenyl group and an alkoxy group having 1 to 20 carbon atoms. More preferably, there is mentioned an alkyl group having 1 to 4 carbon atoms, a phenyl group or an alkoxy group having 1 to 12 carbon atoms. Examples of an alkyl or aryl group of R³ include a methyl group, an ethyl group, a phenyl group or the like, of which a methyl group is preferred. Examples of R⁴ include a methyl group, an ethyl group, a tert-butyl group, an octyl group, a decyl group, a dodecyl group or the like for alkyl group; a phenyl group, a xylyl group, a tolyl group or the like for aryl group; a benzyl group or the like for aralkyl group; a vinyl group, a propenyl group, a pentenyl group or the like for alkenyl group; and an alkoxy group such as a methoxy group, an ethoxy group, a propoxy group, a butoxy group, an octoxy group, a dodecoxy group or the like, an aryloxy group such as a phenoxy group or the like, and an alkenyloxy group such as a vinyloxy group, a propenyloxy group, a pentenyloxy group or the like for organoxy group. Preferably, those groups as defined in R² are mentioned. Examples of an alkyl group, aryl group, aralkyl group and alkenyl group of R⁵ include a methyl group, an ethyl group, a propyl group, a butyl group, a tert-butyl group, an octyl group, a decyl group, a dodecyl group, a phenyl group, a benzyl group, a vinyl group, a propenyl group, a pentenyl group and the like, of which an alkyl group having 1 to 12 carbon atoms is preferred.

Since the mercapto group of the organosilicon compound of the invention is protected with the silyl group, the mercapto odor is significantly reduced. When the organosilicon compound of the invention is mixed with water or an alcohol, the silyl group is deprotected, thus leading to the regeneration of mercapto group. Thus, the organosilicon compound of the invention can be utilized as a mercaptosilane reduced in mercapto odor.

The organosilicon compound of the invention can be obtained, for example, by dehydrogenation reaction between an organosilicon compound having one or more mercapto groups and an organosilicon compound having one or more Si—H bonds in the presence of a catalyst.

The side product produced in the preparation method of the invention is hydrogen and thus, there is no filtrate. Additionally, the reaction well proceeds in a solvent-free condition, so that the preparation method is very high in productivity.

When the organosilicon compound of the invention is prepared, a solvent may be used, if necessary. The type of solvent is not critical so far as it is non-reactive with the starting materials of an organosilicon compound having a mercapto group and an organosilicon compound having an Si—H bond. Specifically, mention is made of an aliphatic hydrocarbon solvent such as pentane, hexane, heptane, decane or the like, an ether solvent such as diethyl ether, tetrahydrofuran, 1,4-dioxane or the like, an amide solvent such as dimethylformamide, N-methylpyrrolidone or the like, or an aromatic hydrocarbon solvent such as benzene, toluene, xylene or the like.

In this case, for obtaining organosilicon compound of the above formulas (1) to (9), an organosilicon compound of the following general formula (i) having a mercapto group and an organosilicon compound of the following general formula (ii) having an Si—H bond are reacted thereby forming a sulfur-silicon bond:

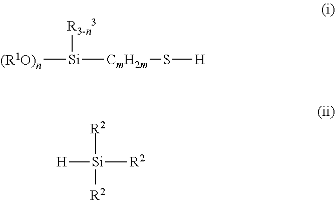

wherein R¹, R², R³, n and m, respectively, have the same meanings as defined before.

The starting organosilicon compound having a mercapto group, which is necessary for preparing the organosilicon compound of the invention, is not critical in type. Specific examples include α-mercaptomethyltrimethoxysilane, α-mercaptomethylmethyldimethoxysilane, α-mercaptomethyldimethylmethoxysilane, α-mercaptomethyltriethoxysilane, α-mercaptomethylmethyldiethoxysilane, α-mercaptomethyldimethylethoxysilane, γ-mercaptopropyltrimethoxysilane, γ-mercaptopropylmethyldimethoxysilane, γ-mercaptopropyldimethylmethoxysilane, γ-mercaptopropyltriethoxysilane, γ-mercaptopropylmethyldiethoxysilane, γ-mercaptopropyldimethylethoxysilane and the like although not limited thereto.

The starting organosilicon compound having an Si—H bond, which is necessary for preparing the organosilicon compound of the invention, is not critical in type. Specific examples include trimethylsilane, ethyldimethylsilane, diethylmethylsilane, triethylsilane, tert-butyldimethylsilane, tert-butyldiphenylsilane, triisopropylsilane, tri-n-butylsilane, triisobutylsilane, dimethylphenylsilane, diphenylmethylsilane, dimethyl-n-octylsilane, decyldimethylsilane, dodecyldimethylsilane, dimethylvinylsilane, triphenylsilane, triethoxysilane, tributoxysilane, dimethylethoxysilane, dimethylbutoxysilane, dimethyloctoxysilane, dimethyldodecoxysilane, and the like.

The catalyst necessary for the preparation of the organosilicon compound of the invention includes a transition metal catalyst or a Lewis acid catalyst. The transition metal catalyst includes a ruthenium catalyst, a rhodium catalyst, a palladium catalyst, an iridium catalyst, a platinum catalyst, a gold catalyst or the like, of which a rhodium catalyst is preferred. RhCl(PPh₃)₃ is more preferred.

As a Lewis acid catalyst, mention is made of aluminum chloride, aluminum sulfate, stannic chloride, stannic sulfate chloride, ferric chloride, boron trifluoride, (pentafluorophenyl)borate and the like, of which (pentafluorophenyl)borate is preferred.

In the preparation of the organosilicon compound of the invention, the reaction is preferably carried out in view of the reactivity and productivity in such a way that a ratio of an organosilicon compound having a mercapto group and an organosilicon compound having a Si—H bond is within a range of 0.5 to 1.5 mol, preferably 0.9 to 1.1 mol of the Si—H bond per mole of the mercapto group.

In the preparation of the organosilicon compound of the invention, the reaction is preferably carried out in view of the reactivity and productivity in such a way that a ratio of an organosilicon compound having a mercapto group and a catalyst is within a range of 0.000001 to 0.1 mol, preferably 0.000001 to 0.001 mol of the catalyst per mole of the mercapto group.

For the preparation of the organosilicon compound of the invention, the reaction temperature is not critical and is generally within a range of room temperature to boiling points of starting reactants and an organic solvent. Preferably, the reaction is carried out at 50° C. to 150° C., more preferably at 60° C. to 120° C. The reaction time is not critical so far as it is sufficient to allow the reaction to proceed. The reaction time is preferably at about 30 minutes to 24 hours, more preferably at about 1 to 10 hours.

The organosilicon compound of the invention is conveniently used as a compounding agent for rubber.

The compounding agent for rubber of the invention may be one wherein organosilicon compound as component (A) of the invention is preliminarily mixed with at least one powder as component (B) to provide a compounding agent. As powder (B), carbon black, talc, calcium carbonate, stearic acid, silica, aluminum hydroxide, alumina, magnesium hydroxide and the like are exemplified. In view of reinforcement, silica and aluminum hydroxide are preferred, of which silica is more preferred.

The amount of powder (B) is such that components (A)/(B) is preferably at 70/30 to 5/95, more preferably at 60/40 to 10/90 on weight basis. If the amount of powder (B) is smaller, the compounding agent for rubber becomes liquid in nature with some cases that charge into a rubber kneader may become difficult. If the amount of powder (B) is larger, a total amount becomes larger relative to an effective amount of the compounding agent for rubber, so that the transport costs may become high.

The compounding agent for rubber of the invention may be a mixed one with a fatty acid, a fatty acid salt, or an organic polymer or rubber such as polyethylene, polypropylene, a polyoxyalkylene, a polyester, a polyurethane, polystyrene, polybutadiene, polyisoprene, natural rubber, a styrene-butadiene copolymer or the like. Moreover, a variety of additives ordinarily formulated in tires and other general rubber may also be formulated including a vulcanizer, a crosslinking agent, a vulcanization accelerator, crosslinking promoter, various types of oils, an antiaging agent, a filler, a plasticizer and the like. These additives may be either liquid or solid in nature, or may be diluted with an organic solvent or may be emulsified.

The compounding agent for rubber of the invention can be conveniently used in rubber compositions formulated with silica.

In this case, the amount of the compounding agent for rubber is preferably such that the organosilicon compound of the invention is at 0.2 to 30 parts by weight, more preferably at 1.0 to 20 parts by weight per 100 parts by weight of the filler formulated in a rubber composition. If the amount of the organosilicon compound is smaller, desired rubber physical properties cannot be obtained. In contrast, when the amount is larger, the effect against the amount is saturated, thus being poor in economy.

As a rubber formulated as a main component of rubber compositions in which the compounding agent for rubber of the invention is used, arbitrary rubbers ordinarily formulated in hitherto known various types of rubber compositions can be used including, for example, natural rubber (NR), diene rubbers such as isoprene rubber (IR), various types of styrene-butadiene copolymer rubbers (SBR), various types of polybutadiene rubbers (BR), acrylonitrile-butadiene copolymer rubbers (NBR), butyl rubber (IIR), etc., and ethylene-propylene copolymer rubbers (EPR, EPDM), and may be used singly or in arbitrary blends. Fillers to be formulated include silica, talc, clay, aluminum hydroxide, magnesium hydroxide, calcium carbonate, titanium oxide and the like.

The rubber composition making use of the compounding agent for rubber according to the invention may be further formulated, aside from the afore-stated essential components, with a variety of additives ordinarily formulated in tires and other general rubber including carbon black, a vulcanizer, a crosslinking agent, a vulcanization accelerator, crosslinking promoter, various types of oils, an antiaging agent, a filler, a plasticizer and the like. The amounts of these additives may be those ordinarily used so far as they are not contrary to the purposes of the invention.

It will be noted that although the organosilicon compound of the invention may be used instead of known silane coupling agents in these rubber compositions, other types of silane coupling agents may be optionally added. Arbitrary silane coupling agents, which have been hitherto used in combination with a silica filler, may be added to the composition. Typical examples of such a silane coupling agent include vinyltrimethoxysilane, vinyltriethoxysilane, γ-glycidoxypropyltrimethoxysilane, γ-glycidoxypropyltriethoxysilane, γ-aminopropyltriethoxysilane, β-aminoethyl-γ-aminopropyltrimethoxysilane, β-aminoethyl-γ-aminopropyltriethoxysilane, γ-mercaptopropyltrimethoxysilane, γ-mercaptopropyltriethoxysilane, γ-methacryloxypropyltrimethoxysilane, γ-methacryloxypropyltriethoxysilane, γ-acryloxypropyltrimethoxysilane, γ-acryloxypropyltriethoxysilane, bis-triethoxysilylpropyltetrasulfide, bis-triethoxysilylpropyldisulfide and the like.

The rubber composition formulated with the compounding agent for rubber of the invention can be formed as a composition after kneading and vulcanization with ordinary methods and can be provided for vulcanization or crosslinkage.

The tire of the invention is characterized by being formed from the above rubber composition and the rubber composition is preferably used as a tread. The tire of the invention is not only remarkably reduced in rolling resistance, but also significantly improved in wear resistance. It will be noted that the tire of the invention has a conventionally known structure, which is not specifically limitative, and can be made by ordinary methods. Where the tire of the invention is provided as a pneumatic tire, such a gas to be filled in the tire includes not only ordinary air or air whose partial pressure of oxygen is controlled, but also an inert gas such as nitrogen, argon, helium or the like.

### EXAMPLES

Examples and Comparative Examples are shown to illustrate the invention in more detail and the invention should not be construed as limited to these Examples. NMR in the Examples means an abbreviation for nuclear magnetic resonance spectroscopy.

### Example 1

238.4 g (1.0 mol) of γ-mercaptopropyltriethoxysilane (KBE-803, made by Shin-Etsu Chemical Co., Ltd.) and 0.069 g (7.5×10⁻⁵ mol) of RhCl(PPh₃)₃ were placed in a one-liter separable flask equipped with an agitator, a reflux condenser, a dropping funnel and a thermometer and heated on an oil bath at 80° C. Thereafter, 116.3 g (1.0 mol) of triethylsilane (LS-1320, made by Shin-Etsu Chemical Co., Ltd.) was dropped. The mixture was heated under agitation at 90° C. for five hours, followed by confirming the complete disappearance of the Si—H bond of the starting material by measurement with IR, thereby completing the reaction. Subsequently, 349.3 g of the resulting reaction product, which was obtained by concentration with rotary evaporator under reduced pressure, was transparent yellow liquid. It was confirmed according to ¹H NMR spectra that the reaction product had the structure represented by the following chemical structural formula (10). The ¹H NMR spectral data of the compound are indicated below.

¹H NMR (300 MHz, CDCl₃, δ (ppm)): 0.69 (m, 8H), 0.95 (t, 9H), 1.17 (t, 9H), 1.67 (m, 2H), 2.45 (t, 2H), 3.77 (t, 6H)

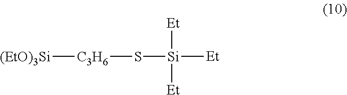

In the formula, Et is an ethyl group herein and whenever it appears hereinafter.

### Example 2

238.4 g (1.0 mol) of γ-mercaptopropyltriethoxysilane (KBE-803, made by Shin-Etsu Chemical Co., Ltd.) and 0.069 g (7.5×10⁻⁵ mol) of RhCl(PPh₃)₃ were placed in a one-liter separable flask equipped with an agitator, a reflux condenser, a dropping funnel and a thermometer and heated on an oil bath at 80° C. Thereafter, 116.3 g (1.0 mol) of tert-butyldimethylsilane was dropped. The mixture was heated under agitation at 90° C. for five hours, followed by confirming complete disappearance of the Si—H bond of the starting material by measurement with IR, thereby completing the reaction. Subsequently, 347.7 g of the reaction product, which was obtained by concentration with a rotary evaporator under reduced pressure, was transparent yellow liquid. It was confirmed according to ¹H NMR spectra that the reaction product had the structure represented by the following chemical structural formula (11). The ¹H NMR spectral data of the compound are indicated below.

¹H NMR (300 MHz, CDCl₃, δ (ppm)): 0.48 (s, 6H), 0.65 (t, 2H), 0.83 (s, 9H), 1.12 (s, 9H), 1.52 (m, 2H), 2.31 (t, 2H), 3.72 (t, 6H)

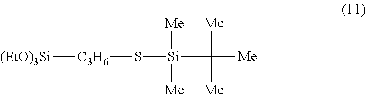

In the formula, Me is a methyl group herein and whenever it appears hereinafter.

### Example 3

238.4 g (1.0 mol) of γ-mercaptopropyltriethoxysilane (KBE-803, made by Shin-Etsu Chemical Co., Ltd.) and 0.069 g (7.5×10⁻⁵ mol) of RhCl(PPh₃)₃ were placed in a one-liter separable flask equipped with an agitator, a reflux condenser, a dropping funnel and a thermometer and heated on an oil bath at 80° C. Thereafter, 136.3 g (1.0 mol) of dimethylphenylsilane (LS-2010, made by Shin-Etsu Chemical Co., Ltd.) was dropped. The mixture was heated under agitation at 90° C. for five hours, followed by confirming complete disappearance of the Si—H bond of the starting material by measurement with IR, thereby completing the reaction. Subsequently, 367.3 g of the resulting reaction product, which was obtained by concentration with a rotary evaporator under reduced pressure, was transparent yellow liquid. It was confirmed according to ¹H NMR spectra that the reaction product had the structure represented by the following chemical structural formula (12). The ¹H NMR spectral data of the compound are indicated below.

¹H NMR (300 MHz, CDCl₃, δ (ppm)): 0.49 (s, 6H), 0.62 (t, 2H), 1.12 (t, 9H), 1.53 (m, 2H), 2.31 (t, 2H), 3.72 (t, 6H), 7.30 to 7.38 (m, 3H), 7.45 to 7.52 (m, 2H)

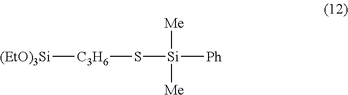

In the formula, Ph is a phenyl group herein and whenever it appears hereinafter.

### Example 4

238.4 g (1.0 mol) of γ-mercaptopropyltriethoxysilane (KBE-803, made by Shin-Etsu Chemical Co., Ltd.) and 0.069 g (7.5×10⁻⁵ mol) of RhCl(PPh₃)₃ were placed in a one-liter separable flask equipped with an agitator, a reflux condenser, a dropping funnel and a thermometer and heated on an oil bath at 80° C. Thereafter, 198.3 g (1.0 mol) of diphenylmethylsilane (LS-4880, made by Shin-Etsu Chemical Co., Ltd.) was dropped. The mixture was heated under agitation at 90° C. for five hours, followed by confirming complete disappearance of the Si—H bond of the starting material by measurement with IR, thereby completing the reaction. Subsequently, 412.7 g of the resulting reaction product, which was obtained by concentration with a rotary evaporator under reduced pressure, was transparent yellow liquid. It was confirmed according to ¹H NMR spectra that the reaction product had the structure represented by the following chemical structural formula (13). The ¹H NMR spectral data of the compound are indicated below.

¹H NMR (300 MHz, CDCl₃, δ (ppm)): 0.50 (s, 3H), 0.61 (t, 2H), 1.12 (t, 9H), 1.53 (m, 2H), 2.31 (t, 2H), 3.71 (t, 6H), 7.31 to 7.39 (m, 6H), 7.43 to 7.57 (m, 4H)

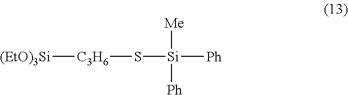

### Example 5

238.4 g (1.0 mol) of γ-mercaptopropyltriethoxysilane (KBE-803, made by Shin-Etsu Chemical Co., Ltd.) and 0.069 g (7.5×10⁻⁵ mol) of RhCl(PPh₃)₃ were placed in a one-liter separable flask equipped with an agitator, a reflux condenser, a dropping funnel and a thermometer and heated on an oil bath at 80° C. Thereafter, 294.9 g (1.0 mol) of triphenylsilane (LS-6390, made by Shin-Etsu Chemical Co., Ltd.) was dropped. The mixture was heated under agitation at 90° C. for five hours, followed by confirming complete disappearance of the Si—H bond of the starting material by measurement with IR, thereby completing the reaction. Subsequently, 477.3 g of the resulting reaction product, which was obtained by concentration with a rotary evaporator under reduced pressure, was transparent yellow liquid. It was confirmed according to ¹H NMR spectra that the reaction product had the structure represented by the following chemical structural formula (14). The ¹H NMR spectral data of the compound are indicated below.

¹H NMR (300 MHz, CDCl₃, δ (ppm)): 0.61 (t, 2H), 1.12 (t, 9H), 1.53 (m, 2H), 2.31 (t, 2H), 3.71 (t, 6H), 7.30 to 7.39 (m, 9H), 7.42 to 7.59 (m, 6H)

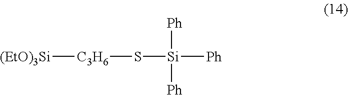

### Example 6

238.4 g (1.0 mol) of γ-mercaptopropyltriethoxysilane (KBE-803, made by Shin-Etsu Chemical Co., Ltd.) and 0.069 g (7.5×10⁻⁵ mol) of RhCl(PPh₃)₃ were placed in a one-liter separable flask equipped with an agitator, a reflux condenser, a dropping funnel and a thermometer and heated on an oil bath at 80° C. Thereafter, 164.3 g (1.0 mol) of triethoxysilane (KBE-03, made by Shin-Etsu Chemical Co., Ltd.) was dropped. The mixture was heated under agitation at 90° C. for five hours, followed by confirming complete disappearance of the Si—H bond of the starting material by measurement with IR, thereby completing the reaction. Subsequently, 379.7 g of the resulting reaction product, which was obtained by concentration with a rotary evaporator under reduced pressure, was transparent yellow liquid. It was confirmed according to ¹H NMR spectra that the reaction product had the structure represented by the following chemical structural formula (15). The ¹H NMR spectral data of the compound are indicated below.

¹H NMR (300 MHz, CDCl₃, δ (ppm)): 0.61 (m, 2H), 1.11 (m, 18H), 1.63 (m, 2H), 2.50 (t, 2H), 3.70 (t, 6H), 3.77 (t, 6H)

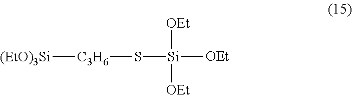

### Example 7

238.4 g (1.0 mol) of γ-mercaptopropyltriethoxysilane (KBE-803, made by Shin-Etsu Chemical Co., Ltd.) and 0.069 g (7.5×10⁻⁵ mol) of RhCl(PPh₃)₃ were placed in a one-liter separable flask equipped with an agitator, a reflux condenser, a dropping funnel and a thermometer and heated on an oil bath at 80° C. Thereafter, 188.4 g (1.0 mol) of dimethyloctoxysilane was dropped. The mixture was heated under agitation at 90° C. for five hours, followed by confirming complete disappearance of the Si—H bond of the starting material by measurement with IR, thereby completing the reaction. Subsequently, 411.1 g of the resulting reaction product, which was obtained by concentration with a rotary evaporator under reduced pressure, was transparent yellow liquid. It was confirmed according to ¹H NMR spectra that the reaction product had the structure represented by the following chemical structural formula (16). The ¹H NMR spectral data of the compound are indicated below.

¹H NMR (300 MHz, CDCl₃, δ (ppm)): 0.25 (s, 6H), 0.63 (t, 2H), 0.77 (t, 3H), 1.12 (t, 9H), 1.14 to 1.29 (m, 10H), 1.44 (m, 2H), 1.61 (m, 2H), 2.47 (t, 2H), 3.57 (t, 2H), 3.70 (t, 6H)

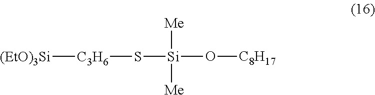

### Example 8

238.4 g (1.0 mol) of γ-mercaptopropyltriethoxysilane (KBE-803, made by Shin-Etsu Chemical Co., Ltd.) and 0.069 g (7.5×10⁻⁵ mol) of RhCl(PPh₃)₃ were placed in a one-liter separable flask equipped with an agitator, a reflux condenser, a dropping funnel and a thermometer and heated on an oil bath at 80° C. Thereafter, 244.5 g (1.0 mol) of dimethyldodecoxysilane was dropped. The mixture was heated under agitation at 90° C. for five hours, followed by confirming complete disappearance of the Si—H bond of the starting material by measurement with IR, thereby completing the reaction. Subsequently, 437.4 g of the resulting reaction product, which was obtained by concentration with a rotary evaporator under reduced pressure, was transparent yellow liquid. It was confirmed according to ¹H NMR spectra that the reaction product had the structure represented by the following chemical structural formula (17). The ¹H NMR spectral data of the compound are indicated below.

¹H NMR (300 MHz, CDCl₃, δ (ppm)): 0.25 (s, 6H), 0.63 (t, 2H), 0.77 (t, 3H), 1.12 (t, 9H), 1.12 to 1.32 (m, 14H), 1.44 (m, 2H), 1.61 (m, 2H), 2.47 (t, 2H), 3.57 (t, 2H), 3.70 (t, 6H)

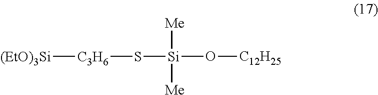

### Example 9

238.4 g (1.0 mol) of γ-mercaptopropyltriethoxysilane (KBE-803, made by Shin-Etsu Chemical Co., Ltd.) and 0.051 g (1.0×10⁻⁴ mol) of pentafluorophenyl borate were placed in a one-liter separable flask equipped with an agitator, a reflux condenser, a dropping funnel and a thermometer and heated on an oil bath at 90° C. Thereafter, 116.3 g (1.0 mol) of triethylsilane (LS-1320, made by Shin-Etsu Chemical Co., Ltd.) was dropped. The mixture was heated under agitation at 90° C. for five hours, followed by confirming complete disappearance of the Si—H bond of the starting material by measurement with IR, thereby completing the reaction. Subsequently, 345.8 g of the resulting reaction product, which was obtained by concentration with a rotary evaporator under reduced pressure, was transparent yellow liquid. It was confirmed according to ¹H NMR spectra that the reaction product had the structure represented by the above chemical structural formula (10). The ¹H NMR spectral data of the compound are indicated below.

¹H NMR (300 MHz, CDCl₃, δ (ppm)): 0.69 (m, 8H), 0.95 (t, 9H), 1.17 (t, 9H), 1.67 (m, 2H), 2.45 (t, 2H), 3.77 (t, 6H)

### Examples 10 to 17 and Comparative Examples 1 to 3

110 parts by weight of oil-extended emulsion polymerization SBR (#1712, made by JSR corporation), 20 parts by weight of NR (general-purpose RSS #3 grade), 20 parts by weight of carbon black (general-purpose N234 grade), 50 parts by weight of silica (Nipsil AQ, made by Nippon Silica Industrial Co., Ltd.), 6.5 parts by weight of each of the organosilicon compounds of Examples 1 to 8 or comparative compounds A to C indicated below, 1 part by weight of stearic acid, and 1 part by weight of antiaging agent 6C (Nocrac 6C, made by Ouchi Shinko Chemical Industrial Co., Ltd.) were formulated to prepare a master batch. This master batch was admixed with 3.0 parts by weight of zinc oxide, 0.5 parts by weight of vulcanization accelerator DM (dibenzothiazyl disulfide), 1.0 part by weight of vulcanization accelerator NS(N-t-butyl-2-benzothiazolyl sulfeneamide) and 1.5 parts by weight of sulfur and kneaded to obtain a rubber composition.

Next, the physical properties of unvulcanized or vulcanized rubber compositions were measured according to the following methods. The results of evaluation of the examples and comparative examples are shown in Tables 1, 2.

### Physical Properties of Unvulcanized Composition

### (1) Mooney Viscosity

According to JIS K 6300, measurement was made under conditions including a residual heat over one minute, a measurement over four minutes and a temperature of 130° C. and the resulting measurement was indicated as an index when Comparative Example 1 was taken as 100. A smaller value of the index indicates a smaller Mooney viscosity, thus being excellent in processability.

### Physical Properties of Vulcanized Composition

### (2) Dynamic Viscoelasticity

Using a viscoelasticity measuring device (made by TA Instruments—Waters LLC), measurement was made under conditions of a tensile dynamic strain of 5%, a frequency of 15 Hz and 60° C. It will be noted that a test piece used was a sheet having a thickness of 0.2 cm and a width of 0.5 cm, a clipping distance used was set at 2 cm and an initial load was at 160 g. The value of tan δ was indicated as an index when that of Comparative Example 1 was taken as 100. A smaller index value leads to a smaller hysteresis loss, thus showing low heat generating property.

### (3) Wear Resistance

According to JIS K 6264-2:2005, a test was carried out using the Lambourn abrasion tester under conditions of room temperature and a slip ratio of 25%, and the results are indicated as an index relative to the reciprocal of a wear volume in Comparative Example 1 taken as 100. A larger index value leads to a smaller wear volume, showing an excellent wear resistance.

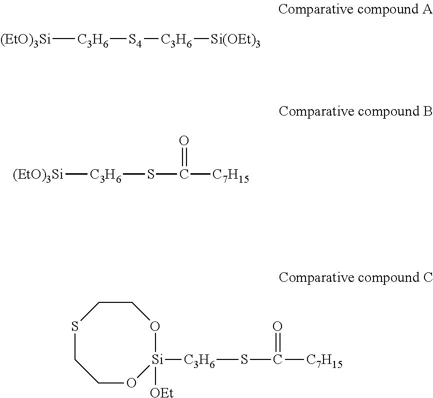

TABLE 1

| | | Example | | | | | |
|---|---|---|---|---|---|---|---|
| | | 10 | 11 | 12 | 13 | 14 | 15 |
| Formulation | SBR | 110 | 110 | 110 | 110 | 110 | 110 |
| (parts by | NR | 20 | 20 | 20 | 20 | 20 | 20 |
| weight) | Carbon black | 20 | 20 | 20 | 20 | 20 | 20 |
| | Silica | 50 | 50 | 50 | 50 | 50 | 50 |
| | Stearic acid | 1 | 1 | 1 | 1 | 1 | 1 |
| | 6C | 1 | 1 | 1 | 1 | 1 | 1 |
| | Zinc oxide | 3 | 3 | 3 | 3 | 3 | 3 |
| | DM | 0.5 | 0.5 | 0.5 | 0.5 | 0.5 | 0.5 |
| | NS | 1 | 1 | 1 | 1 | 1 | 1 |
| | Sulfur | 1.5 | 1.5 | 1.5 | 1.5 | 1.5 | 1.5 |
| | Compound of | 6.5 | — | — | — | — | — |
| | formula (10) | | | | | | |
| | Compound of | — | 6.5 | — | — | — | — |
| | formula (11) | | | | | | |
| | Compound of | — | — | 6.5 | — | — | — |
| | formula (12) | | | | | | |
| | Compound of | — | — | — | 6.5 | — | — |
| | formula (13) | | | | | | |
| | Compound of | — | — | — | — | 6.5 | — |
| | formula (14) | | | | | | |
| | Compound of | — | — | — | — | — | 6.5 |
| | formula (15) | | | | | | |
| Physical | Mooney | 98 | 97 | 97 | 98 | 97 | 97 |
| property of | viscosity | | | | | | |
| unvulcanized | | | | | | | |
| composition | | | | | | | |
| Physical | Dynamic | 98 | 97 | 97 | 95 | 96 | 95 |
| properties | viscoelasticity | | | | | | |
| of | tanδ (60° C.) | | | | | | |
| vulcanized | Wear resistance | 102 | 103 | 105 | 105 | 104 | 106 |
| composition | | | | | | | |

TABLE 2

| | | | | Comparative | | |
|---|---|---|---|---|---|---|
| | | Example | | Example | | |
| | | 16 | 17 | 1 | 2 | 3 |
| Formulation | SBR | 110 | 110 | 110 | 110 | 110 |
| (parts by | NR | 20 | 20 | 20 | 20 | 20 |
| weight) | Carbon black | 20 | 20 | 20 | 20 | 20 |
| | Silica | 50 | 50 | 50 | 50 | 50 |
| | Stearic acid | 1 | 1 | 1 | 1 | 1 |
| | 6C | 1 | 1 | 1 | 1 | 1 |
| | Zinc oxide | 3 | 3 | 3 | 3 | 3 |
| | DM | 0.5 | 0.5 | 0.5 | 0.5 | 0.5 |
| | NS | 1 | 1 | 1 | 1 | 1 |
| | Sulfur | 1.5 | 1.5 | 1.5 | 1.5 | 1.5 |
| | Compound of | 6.5 | — | — | — | — |
| | formula (16) | | | | | |
| | Compound of | — | 6.5 | — | — | — |
| | formula (17) | | | | | |
| | Comparative | — | — | 6.5 | — | — |
| | Compound A | | | | | |
| | Comparative | — | — | — | 6.5 | — |
| | Compound B | | | | | |
| | Comparative | — | — | — | — | 6.5 |
| | Compound C | | | | | |
| Physical | Mooney viscosity | 97 | 97 | 100 | 98 | 97 |
| property of | | | | | | |
| unvulcanized | | | | | | |
| composition | | | | | | |
| Physical | Dynamic | 95 | 95 | 100 | 99 | 98 |
| properties | viscoelasticity tanδ | | | | | |
| of vulcanized | (60° C.) | | | | | |
| composition | Wear resistance | 104 | 105 | 100 | 101 | 101 |

Japanese Patent Application No. 2011-267720 is incorporated herein by reference.

Although some preferred embodiments have been described, many modifications and variations may be made thereto in light of the above teachings. It is therefore to be understood that the invention may be practiced otherwise than as specifically described without departing from the scope of the appended claims.

1. An organosilicon compound of the following general formula (1): 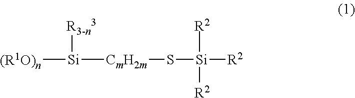
wherein R¹ is an unsubstituted or substituted alkyl group having 1 to 10 carbon atoms or an unsubstituted or substituted aryl group having 6 to 10 carbon atoms, R² is independently an unsubstituted or substituted alkyl group having 1 to 20 carbon atoms, an unsubstituted or substituted aryl group having 6 to 10 carbon atoms, an unsubstituted or substituted aralkyl group having 7 to 10 carbon atoms, an unsubstituted or substituted alkenyl group having 2 to 10 carbon atoms or an unsubstituted or substituted organoxy group having 1 to 20 carbon atoms, R³ is an unsubstituted or substituted alkyl group having 1 to 10 carbon atoms or an unsubstituted or substituted aryl group having 6 to 10 carbon atoms, n is an integer of 1 to 3, and m is an integer of 1 to 3.

2. The organosilicon compound of claim 1, wherein said organosilicon compound is represented by the following general formula (2): 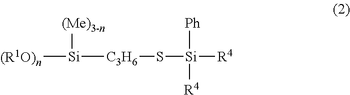
wherein R¹ and n, respectively, have the same meanings as defined above, R⁴ is independently an unsubstituted or substituted alkyl group having 1 to 20 carbon atoms, an unsubstituted or substituted aryl group having 6 to 10 carbon atoms, an unsubstituted or substituted aralkyl group having 7 to 10 carbon atoms, an unsubstituted or substituted alkenyl group having 2 to 10 carbon atoms or an unsubstituted or substituted organoxy group having 1 to 20 carbon atoms, Me is a methyl group and Ph is a phenyl group.

3. The organosilicon compound of claim 1, wherein said organosilicon compound is represented by the following general formula (3): 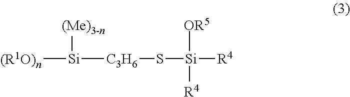
wherein R¹ and n, respectively, have the same meanings as defined above, R⁴ is independently an unsubstituted or substituted alkyl group having 1 to 20 carbon atoms, an unsubstituted or substituted aryl group having 6 to 10 carbon atoms, an unsubstituted or substituted aralkyl group having 7 to 10 carbon atoms, an unsubstituted or substituted alkenyl group having 2 to 10 carbon atoms or an unsubstituted or substituted organoxy group having 1 to 20 carbon atoms, R⁵ is an unsubstituted or substituted alkyl group having 1 to 20 carbon atoms, an unsubstituted or substituted aryl group having 6 to 10 carbon atoms, an unsubstituted or substituted aralkyl group having 7 to 10 carbon atoms or an unsubstituted or substituted alkenyl group having 2 to 10 carbon atoms, and Me is a methyl group.

4. The organosilicon compound of claim 1, wherein said organosilicon compound is represented by any of the following general formulas (4) to (9): 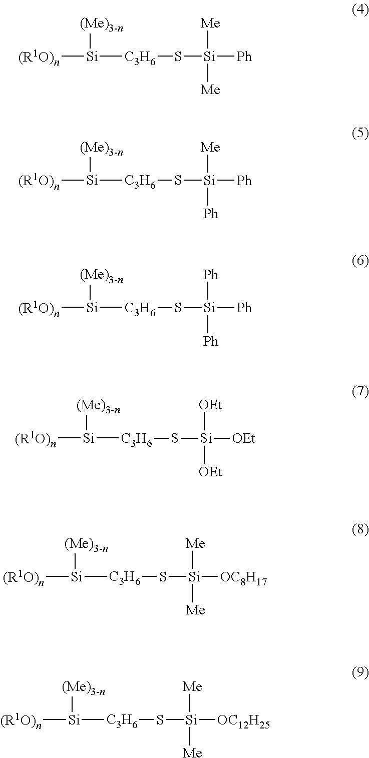
wherein R¹ and n, respectively, have the same meanings as defined above, Me is a methyl group, Et is an ethyl group and Ph is a phenyl group.

5. The organosilicon compound of claim 1, wherein R¹ represents CH₃CH₂.

6. A method for preparing an organosilicon compound defined in claim 1, comprising
reacting, in the presence of a catalyst, an organosilicon compound of the following general formula (i) having a mercapto group with an organosilicon compound of the following general formula (ii) having an Si—H bond to form a sulfur-silicon bond: 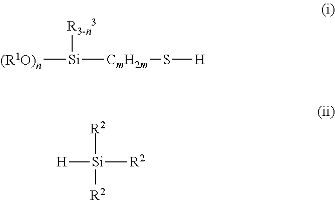
wherein R¹ is an unsubstituted or substituted alkyl group having 1 to 10 carbon atoms or an unsubstituted or substituted aryl group having 6 to 10 carbon atoms, R² is independently an unsubstituted or substituted alkyl group having 1 to 20 carbon atoms, an unsubstituted or substituted aryl group having 6 to 10 carbon atoms, an unsubstituted or substituted aralkyl group having 7 to 10 carbon atoms, an unsubstituted or substituted alkenyl group having 2 to 10 carbon atoms or an unsubstituted or substituted organoxy group having 1 to 20 carbon atoms, R³ is an unsubstituted or substituted alkyl group having 1 to 10 carbon atoms or an unsubstituted or substituted aryl group having 6 to 10 carbon atoms, n is an integer of 1 to 3, and m is an integer of 1 to 3.

7. The method for preparing an organosilicon compound of claim 6, wherein the catalyst is a transition metal catalyst or a Lewis acid catalyst.

8. The method for preparing an organosilicon compound of claim 7, wherein the transition metal catalyst is RhCl(PPh₃)₃.

9. The method for preparing an organosilicon compound of claim 7, wherein the Lewis acid catalyst is (pentafluorophenyl)boric acid.

10. A compounding agent for rubber comprising
the organosilicon compound defined in claim 1.

11. The compounding agent for rubber of claim 10, further comprising
at least one type of powder
wherein a ratio by weight of the organosilicon compound as component (A) and the at least one type of powder as component (B) is such that (A)/(B)=70/30 to 5/95.

12. A rubber composition comprising
the compounding agent for rubber defined in claim 10, and
a rubber.

13. A tire formed by use of the rubber composition defined in claim 12.
